(19) United States
(12) Patent Application Publication
(10) Pub. No.: US 2021/0243869 A1
(43) Pub. Date: Aug. 5, 2021

(54) LIGHTING SYSTEM VERIFICATION

(71) Applicant: SIGNIFY HOLDING B.V., EINDHOVEN (NL)

(72) Inventor: ASHISH VIJAY PANDHARIPANDE, EINDHOVEN (NL)

(21) Appl. No.: 16/755,293

(22) PCT Filed: Oct. 5, 2018
(86) PCT No.: PCT/EP2018/077116

§ 371 Date: Apr. 10, 2020

(30) Foreign Application Priority Data
Oct. 10, 2017 (EP) 17195722.8

(51) Int. Cl. H05B 47/14; H05B 47/115; H05B 47/11; E06B 9/68; G05B 19/04

(52) U.S. Cl. CPC H05B 47/14; H05B 47/115; H05B 47/11; G05B 2219/2642; G05B 19/0415; E06B 2009/6827; G05B 2219/2639; E06B 9/68

(57) ABSTRACT

Some embodiments are directed to a verification device (200) arranged to verify based on incomplete information. The verification device is arranged to compute an energy consumption estimate for one or more luminaires from occupancy data, and compare it to received energy consumption data. A signal is transmitted if a lack of dependency is found in the lighting system with other factors than occupancy.

### FIELD OF THE INVENTION

The invention relates to a verification device, a lighting system, a lighting system verification method, and a computer readable medium.

### BACKGROUND

Buildings with windows and/or other sources for natural light ingress receive enough daylight to partly illuminate the interior space. In modern lighting systems, the use of electrical lighting can be reduced to conserve energy. This may be done using so-called daylight controls. In such controls, the amount of electric lighting used is controlled based on the amount of daylight present to regulate the net illumination in the space. For instance, a daylight controlled lighting system can dim or switch off luminaires if the amount of available daylight is sufficiently high to meet illumination requirements. The monitoring of illumination is done using light sensors. Daylight controls lead to a reduction of electrical energy consumption due to lighting and can be used to reduce peaks in energy demand.

However, commissioning of daylight control systems can be quite complex in lighting systems [1]. As an example, daylight controls may be designed to operate in very specific manners. However due to installation and eventual lifetime of system operation, the controls may be misconfigured. For example, the building may be reconfigured, e.g., walls may be moved or removed without proper adjustment of the existing lighting system. As another example, the light sensors need to be properly calibrated. Improper calibration can cause under-illumination [2] or annoying light-level fluctuations that can lead to occupant frustration which may even result in occupants sabotaging the system by disabling controls, e.g., by blocking the light sensor.

There is thus a need for automated support to diagnose misconfigured of broken lighting systems. Fortunately, a current trend is that such lighting systems are becoming equipped with large numbers of sensors and are increasingly connected. For example, lighting data may be collected and stored in a backend database or Cloud, etc. Unfortunately, a problem observed by the inventors is that it often happens that not all relevant data is stored. For example, frequently only lighting energy consumption and occupation data is logged, without the light sensor data. There is thus a need for diagnosing or verifying a lighting system based on incomplete information.

In the art, different methods for daylight control are known. For example, in patent [3] more than one light sensor is used to improve calibration and reliability of daylight controls. Based on sensor data from two sensors (one at a luminaire operating in closed-loop and another located elsewhere operating in open-loop mode), improved calibration was proposed. These methods use additional sensors but do not address the problem of validating whether daylight control is working correctly, e.g., according to design intent, or of diagnosing other daylight control misconfigurations.

### REFERENCES (EACH OF WHICH IS INCLUDED HEREIN BY REFERENCE)

[1] Francis Rubinstein, Douglas Avery, Judith Jennings, On the Calibration and Commissioning of Lighting Controls, Proceedings of the Right Light 4 Conference, Nov. 19-21, 1997.
[2] David Caicedo, Ashish Pandharipande, Frans MJ Willems, Light sensor calibration and dimming sequence design in distributed lighting control systems, IEEE 11th International Conference on Networking, Sensing and Control, 2014.
[3] Konstantinos Papamichael, Keith Greater, Erik Page, Michael Siminovitch, Method for preventing incorrect lighting adjustment in a daylight harvesting system, U.S. Pat. No. 7,683,301 B2.

### SUMMARY OF THE INVENTION

A verification device for verifying a lighting system (also simply referred to as a verification device, or verification device) is proposed as defined in the claims. The verification device can identify problems in the lighting system even though it has access only to partial information. For example, verification device may have access to energy consumption and occupancy information, but not to lighting data. Interestingly, the verification device computes an energy consumption estimate based on the partial information, and compares it to the actual energy consumption. If the estimate is too close, that is, if it is possible to estimate energy consumption well without having access to all of the factors that the verification device allegedly takes into account, then it is concluded that the lighting system might not be configured correctly or that there may be a malfunction.

Using a prototype of an embodiment, automated misconfigurations have indeed been detected on the basis of occupancy data, and limited configuration data. In particular, without access to data from light sensors, lighting systems have been identified in which it turned out that light sensor information was not taken into account.

In an embodiment, the lighting system is configured to control multiple luminaires at least partly in response to the occupancy sensors and partly in response to other factors. For example, the other factors may be lighting sensors. Interestingly, verification device may verify the configuration of the lighting system without access to the other factors. For example, in an embodiment, the verification device is configured to transmit a signal indicating a lack of dependency of the lighting system on lighting sensors.

The verification device is an electronic device. For example, it may be a computer, a server, etc.

In an embodiment of the verification device, the one or more luminaires are luminaires that are assigned to a same control zone.

An aspect of the invention concerns a lighting verification method. The method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code stored on a computer readable medium for performing a method according to the invention when said program product is executed on a computer.

In a preferred embodiment, the computer program comprises computer program code adapted to perform all the steps of a method according to the invention when the computer program is run on a computer. Preferably, the computer program is embodied on a computer readable medium.

Another aspect of the invention provides a method of making the computer program available for downloading. This aspect is used when the computer program is available for downloading.

### BRIEF DESCRIPTION OF THE DRAWINGS

Further details, aspects, and embodiments of the invention will be described, by way of example only, with reference to the drawings. Elements in the Figures are illustrated for simplicity and clarity and have not necessarily been drawn to scale. In the Figures, elements which correspond to elements already described may have the same reference numerals. In the drawings,

FIG. 1 schematically shows an example of an embodiment of a lighting system,

FIG. 2 schematically shows an example of an embodiment of a building floor,

FIG. 3 schematically shows an example of an embodiment of a verification device,

FIG. 4 schematically shows an example of an embodiment of a building floor,

FIG. 5a schematically shows an example of an embodiment of estimated energy consumption and actual energy consumption,

FIG. 5b schematically shows an example of an embodiment of estimated energy consumption and actual energy consumption,

FIG. 6 schematically shows an example of an embodiment of a lighting system verification method,

FIG. 7a schematically shows a computer readable medium having a writable part comprising a computer program according to an embodiment,

FIG. 7b schematically shows a representation of a processor system according to an embodiment.

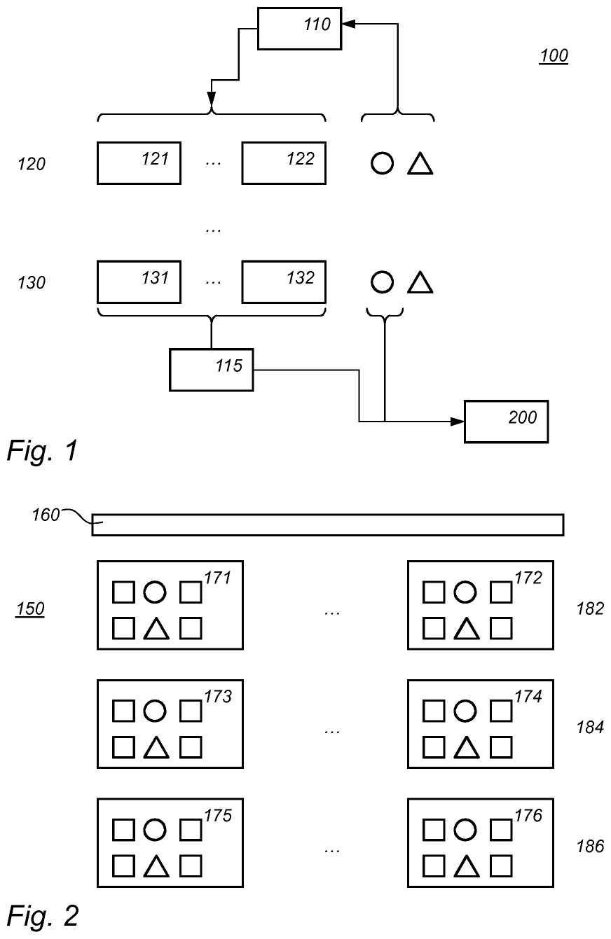

### LIST OF REFERENCE NUMERALS (IN FIGS. 1-5)

100 a lighting system
110 a lighting controller
115 energy measurement device
120 a control zone
121-122 a luminaire
130 a control zone
131-132 a luminaire
150 a building floor
160 a window
171-176 a control zone
182, 184,186 a row
200 a verification device
210 a communication interface
220 an energy estimator
222 a lighting model
230 a comparator
232 a residual unit
234 a correlator unit
236 a sensor
240 a signal generator
250 a configuration storage
400 a building floor
420 a window
401-410 control zones
432 occupation data
434 energy consumption data
436 a signal
440 a verification device
450 a configuration storage
510 an estimated energy consumption
520 a measured energy consumption
530 a measured energy consumption
540 an estimated energy consumption
550 a measured energy consumption
560 a measured energy consumption

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

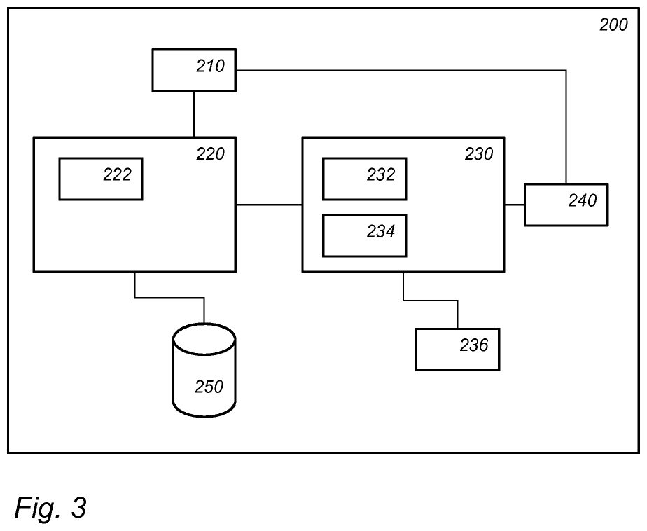

FIG. 1 schematically shows an example of an embodiment of a lighting system 100. System 100 comprises multiple luminaires. In system 100, as is typical in a lighting system, the luminaires are organized in so-called control zones. For example, each luminaire may be assigned to exactly one control zone. For example, in an embodiment, all luminaire in the same control zone are controlled together, e.g., turned on and off or dimmed together. The use of control zones is not necessary though. FIG. 1 shows two control zones: control zone 120 and control zone 130. Shown in FIG. 1, each of the control zones has two luminaires. Control zone 120 comprises luminaires 121 and 122. Control zone 130 comprises luminaires 131 and 132. There can be more or fewer control zones than 2. A control zone can comprise more or fewer than 2 luminaires. To each control zone one or more sensors are assigned. Shown in FIG. 1, each control zone is assigned an occupancy sensor and a light sensor. The occupancy sensors are indicated in FIGS. 1 and 2 with a small circle. The light sensors are indicated in FIGS. 1 and 2 with a small triangle. A control zone may be assigned more than one occupancy sensor and/or more than one light sensor. The occupancy sensors may be so-called PIR sensors.

In an embodiment, the light sensor is a so-called ambient light sensor which measures the ambient light. However, one could also use a daylight light sensor which measures only light of daylight frequencies. We will assume the light sensors are ambient light sensors.

Lighting system 100 comprises a lighting controller 110. Lighting controller 110 is configured to receive sensor measurements from the occupancy and light sensors, and to generate a control signal based thereon. The control signal is sent to the luminaires. For example, lighting controller 110 may be configured to only turn the luminaires of a control zone on if at least one of the occupancy sensors assigned to the control zone detects occupancy in the area illuminated by the control zone, or, e.g., occupancy has been detected in a recent time-period, e.g., the last 5 minutes. When occupancy has been detected, the illumination level of the luminaires may be based on a feedback system. For example, controller 110 may control the dimming level of the luminaires in the control zone so that the light sensors measure a desired illumination level. Interestingly, this mechanism automatically takes into account illumination in the illumination area corresponding to the control zone that comes from other sources than the luminaires of the control zones, e.g., daylight, or light coming from other control zones. The desired illumination level, or the correspondence between sensors and luminaires may be stored in a storage of controller 110 (not shown separately in FIG. 1).

In this embodiment, the control of the lights thus takes into account two factors: occupancy and the light level. There may be other factors that could be taken into account, e.g., time of day, type of occupation, user preference profiles, manual wall switches, etc.

FIG. 2 schematically shows an example of an embodiment of a building floor 150, on which lighting system 100 may be installed. Shown in FIG. 2 are control zones 171-176. Each control zone comprises one or more luminaires, one or more occupancy sensors and one or more light sensors. In FIG. 2 the luminaires are shown as small squares. Lighting system 100 may be installed on part of a floor or on multiple floors as well.

Shown in FIG. 2, is a window 160 which is a source of incident lighting. There may be other sources of incident lighting, e.g., sky lights, other windows, e.g., other luminaires, which may or may not be part of lighting system 100, etc.

Note that in FIG. 2 the control zones are arranged in rows parallel to a window. This is a fairly typical setup for an open office. In this case, the control zones are arranged in three rows: row 182 comprising control zones 171 and 172, row 184 comprising control zones 173 and 174, and row 186 comprising control zones 175 and 176. As the distance from a control zone to window 160 increases, the effect of the light sensors tends to reduce. The particular row that a control zone belongs to, is an example of a distance indication. Another example of a distance indication is, e.g., a distance to the nearest window, say to window 160, e.g., in meters.

Returning to FIG. 1. FIG. 1 also shows a verification device 200. The verification device may be located together with the lighting system 100, e.g., may be integrated with system 110. However, in an embodiment, verification device 200 is located off-site. For example, verification device 200 may be operated by a manufacturer of lighting system 100, or by a service provider or installer of system 100, etc. For example, a possible use case is that lighting system 100 is installed or maintained by local personnel who receive support from off-site personnel who are trained in diagnosing lighting system problem. For example, the latter may use a tool such as verification device 200.

Lighting system 100 comprises an energy measurement device 115 arranged to measure the energy use of lighting system 100, e.g., of the luminaires. Energy measurement device 115 measures at some spatial resolution, e.g., at the level of control zones, and reports at some time resolution, e.g., every 5 minutes, every hour, etc. These resolutions may both be finer or coarser. For example, spatial resolution may be at the level of individual luminaires or at the level of multiple control zones, e.g., an entire floor. For example, energy measurement device 115 may report energy use of a period, e.g., the last 5 minutes in some unit of energy use, e.g., (kilo)watt, or some unit of energy, e.g., (kilo)watt-hours (kwh). Energy measurement device 115 may store, e.g., log the energy use itself or report it, say, to controller 110.

As shown in FIG. 1, some of the data generated by lighting system 100 may be forwarded to verification device 200. Unfortunately, as pointed out above, for various reasons many lighting systems only report part of the relevant data. For example, energy consumption data and occupancy data has various other uses beyond diagnosing lighting systems and are therefore frequently kept, even if the sensor data of the light sensors is not reported. The energy use and other occupancy data may be stored or reported together or separately. This has been illustrated in FIG. 1, by curly braces. At the top of FIG. 1, it has been illustrated that controller 110 receives sensor data both from the occupancy and light sensors. This information is used, e.g., according to some lighting model, to generate a control signal, which controls the luminaires, e.g., luminaires 121-132, e.g., a dimming level thereof. At the bottom of FIG. 1, it is shown that energy use of the luminaires, e.g., luminaires 121-132 is obtained, e.g., through an energy measurement device 115, and is transmitted to device 200. Of the sensor information, only part is obtained, in this case the occupancy information is obtained by device 200, but the lighting information is not.

Note that FIG. 1 has been simplified, and many elements which may be present in an actual embodiment are omitted. For example, the communication between controller 110, the luminaires and sensor may use a computer network, e.g., arranged to exchange digital messages. The network may be wireless and/or wired or a combination thereof. The network may comprise such devices as routers, hubs, gateways and the like. Likewise, the communication between lighting system 100 and device 200 may use a similar computer network. In an embodiment, lighting system 100 saves data, e.g., in a storage, e.g., in an offsite storage, e.g., in the cloud, and device 200 is given access to the storage. In an embodiment, the storage may even be an external hard-disk, or the like. For example, data may be copied or forwarded, or transmitted to device 200 for the purpose of having it analyzed.

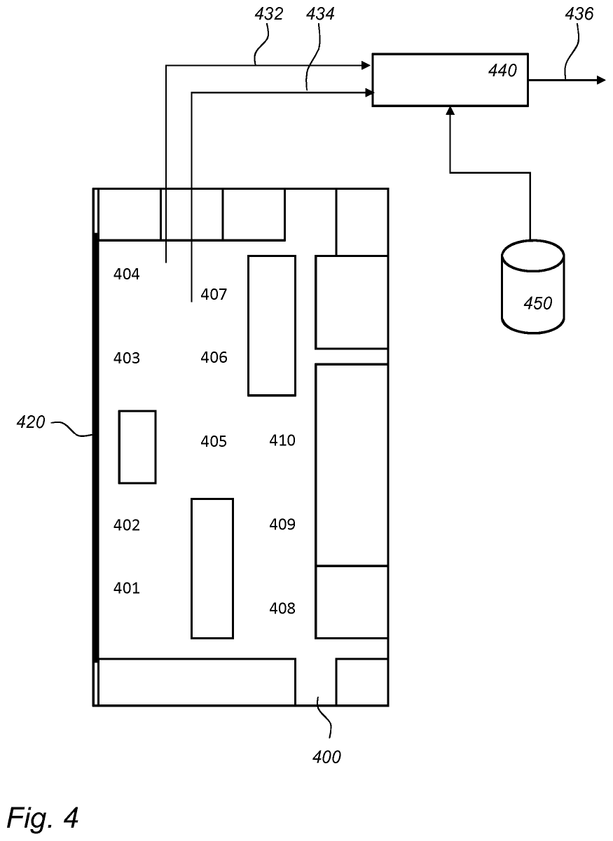

FIG. 3 schematically shows an example of an embodiment of a verification device 200.

Device 200 comprises a communication interface 210. Communication interface 210 is arranged to receive,
energy consumption data indicating energy consumption of one or more of the luminaires,
occupancy data indicating detected occupancy of one or more occupancy sensors, at least one of the luminaires being controlled dependent upon the one or more occupancy sensors.

For example, the energy consumption may be of a particular control zone, and the occupancy data may be of the one or more occupancy sensors assigned to the same control zone. For example, the energy consumption may be of a particular luminaire, and the occupancy data may be of an occupancy sensor controlling that luminaire. In an embodiment, the verification device 200 does not receive data of the light sensors in lighting system 100. In an embodiment, verification device 200 computes an estimate of the energy use under the assumption that the other factors, e.g., the light sensors are not properly used. If the estimated energy consumption turns out to be a fair approximation of the actual energy consumption, it is concluded that the other factors are not properly taken into account. A likely cause may be that lighting system 100 is not configured to take daylight into account. For example, by accident a simpler configuration may be installed which is intended for lighting systems 100 which do not have light sensors. Alternatively, some of the light sensors may be disabled, e.g., by occupants of the building who for some reason dislike the lighting system.

The occupancy data and the energy consumption data may correspond to a same time period. For example, their collected information may be collected within said same time period, e.g. during daytime.

For example, occupancy data may be received at device 200 in a raw format, e.g., it may be a log of the messages sent by the occupancy sensor, possibly together with a timestamp. The occupancy data may also have been processed, e.g., by controller 110. For example, the occupancy information may contain which control zone was occupied at which times. For example, it may be assumed that a luminaire or entire control zone is turned on when a corresponding occupancy sensor detects occupancy, e.g., movement; it may further be assumed that they stay on for a period, say for at least 5 minutes.

Verification device 200 comprises an energy estimator 220. The latter may comprise or otherwise have access to, e.g., comprise, an optional lighting model 222. There is an advantage in using a lighting model 222, but in practice it has turned out that good results can also be obtained without one.

The execution of the verification device 200 is implemented in a processor circuit, examples of which are shown herein. FIG. 3 shows functional units that may be functional units of the processor circuit. For example, FIG. 3 may be used as a blueprint of a possible functional organization of the processor circuit. The processor circuit is not shown separate from the units in FIG. 3. For example, the functional units shown in FIG. 3 may be wholly or partially be implemented in computer instructions that are stored at device 200, e.g., in an electronic memory of device 200, and are executable by a microprocessor of device 200. In hybrid embodiments, functional units are implemented partially in hardware, e.g., as coprocessors, and partially in software stored and executed on device 200.

For example, the occupancy data may comprise multiple data messages comprising, say an occupancy sensor id, and a timestamp, which indicates that the occupancy sensor with that particularly id, detected occupancy at that particular timestamp. The timestamp may be added by lighting system 100, e.g., controller 110, or by the occupancy sensor. For example, the occupancy data may comprise multiple data messages which also comprise occupancy status, which indicate if the occupancy sensor detected occupancy or not. For example, the occupancy data may have been processed and comprise one or more data messages comprising, say, an occupancy sensor id, and a time period, which indicates that there was occupancy in that period. For example, the occupancy data may have been processed and comprise multiple data messages comprising, say, a control zone id and/or a luminaire id, and a time period, which indicates that there was occupancy in that period for that control zone and/or luminaire.

Device 200 may comprise an optional configuration storage 250. Information in configuration storage 250 may be provided by lighting system 100, e.g., controller 100 as well. The information may also be obtained from a third party. Configuration storage 250 comprises information about the configuration of lighting system 100. For example, this information may be obtained from the installer of lighting system 100. For example, configuration storage 250 may comprise an assignment of luminaires to occupancy sensors. In an embodiment, energy estimator 220 maps occupancy information to particular control zones and/or to luminaires using the assignment information.

Energy estimator 220 is configured to compute an energy consumption estimate for the one or more luminaires from the occupancy data. For example, the occupancy data may indicate occupancy of particular control zones. The occupancy data may have a time resolution, e.g., of per minute occupancy information. The energy estimate may have a similar resolution. There are various ways to compute an energy estimate.

In an embodiment, estimator 220 is configured to estimate which of the one or more luminaires are turned on from the occupancy data. For example, estimator 220 may estimate that the luminaires assigned to a particular occupancy sensor are turned on, whenever the occupancy sensor detects occupancy. Once it has been detected which luminaires or control zones are turned on, the energy consumption can be estimated. For example, the estimate may be the product of rated power consumption of the luminaire(s), also referred to as an energy rating, e.g., in kilowatt, and the time the luminaire(s) or control zones are turned on. For example, the energy rating may be obtained from the configuration store 250 as well. It is the aim to estimate the energy of the same number of devices as the received energy consumption. For example, if the energy consumption from system 100 is per control zone, then the energy consumption estimate is also estimated per control zone. In this case, a rated power consumption, i.e., an energy rating, per control zone may be stored in store 250. The energy use may initially be estimated per luminaire and then summed to obtain a per control zone estimate.

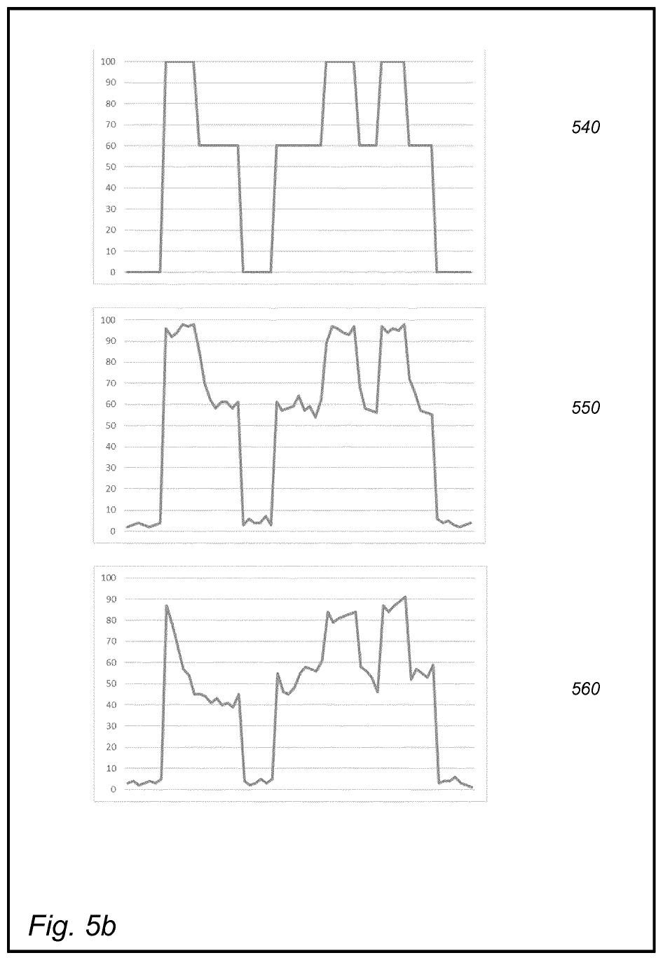

FIG. 5a schematically shows an example of an embodiment of estimated energy consumption and actual energy consumption. An estimated energy consumption 510 is shown. The graph shows energy consumed in an hour, e.g., averaged power over an hour against time. For example, the graph may show energy consumption in a suitable unit, say watt-hour. The graph of FIG. 5a is computed by multiplying occupation with an energy rating. As a result, the graph is a block-graph. Graphs 520 and 530 show a measured energy consumption, e.g., as received from lighting system 100. Measured energy consumption 530 is from a system in which light sensors have correctly been configured and taken into account by controller 110. Measured energy consumption 520 is from a system in which light sensors have not been correctly configured or taken into account by controller 110. It can be seen that estimated graph 510 closely resembles, graph 520 but not graph 530. Accordingly, it can be deduced when graph 520 is received that there is a problem with taking lighting information into account.

FIG. 5b schematically shows an example of an embodiment of estimated energy consumption and an actual energy consumption. Graph 540 is the estimated energy consumption of a control zone. Graphs 550 and 560 are measured energy consumption of the control zone. In this case, the relationship between light output and occupancies is more complex. A luminaire is turned on to a different level depending if its control zone is occupied than if a neighboring zone is occupied. In the first case, the energy use is assumed to be 100% of its energy rating, in the latter case it is assumed to be 60% of its energy rating. As a result, graph 540 has three levels. Graphs 550 and 560 show a measured energy consumption, e.g., as received from lighting system 100. Measured energy consumption 560 is from a system in which light sensors have correctly been configured and taken into account by controller 110. Measured energy consumption 550 is from a system in which light sensors have not been correctly configured or taken into account by controller 110. It can be seen that estimated graph 540 closely resembles, graph 550 but not graph 560. Accordingly, it can be deduced when graph 550 is received that there is a problem with taking lighting information into account.

Returning to FIG. 3. A more advanced way of estimating energy use comprises estimating a dimming level of the one or more luminaires from the occupancy data. For example, a dimming level of individual luminaires, or a dimming level for control zones. In some systems, occupancy determines dimming level as well. For example, in an open office, a control zone is may be illuminated to a first illumination level if it is occupied, and to a second illumination level if it is not occupied but a neighboring zone is occupied. The first illumination level is higher than the second illumination level. This feature avoids the so-called island effect, in which a sole zone is illuminated in an otherwise dark open office. For example, the configuration store 250 may store a dimming relation between occupancy sensors and luminaires to compute the expected dimming levels from the occupancy information. For example, the latter may comprise a series of rules, e.g., if-then rules, which determine dimming level from occupancy status and neighboring occupancy status. Configuration store 250 may also comprise the location of the luminaires or control zones and use this to estimate the dimming relation. For example, as an initial estimate it may be assumed that a dimmed zone is set to 60% of full luminaire power, and an occupied zone to 100%.

For example, one may assume that a 60% dimmed luminaire has an energy rating which is 60% of its full energy rating. In embodiments such as these, if the estimated energy use were graphed a block-graph with more than two levels would emerge. An advantage of taking dimming levels into account is that a better estimate is obtained from occupancy alone. Using the estimate will allow a better distinction between differences caused by bad light sensor configuration and differences caused by the occupancy sensors themselves. It may be the case that some luminaires are not dimmable. In that case one could, e.g., use the dimming level for the dimmable luminaires, and assume that the other luminaires are at full power.

More generally, energy use is estimated based on occupancy data while assuming that the other factors are set to a fixed value. In case the other factors are light sensors, it may be assumed that the light sensors are set to a default value, in particular, to full darkness. This is a setting that would normally drive the lighting system to create as high light output.

In an embodiment, estimator 220 uses a data model 222. For example, the data model may be implemented in computer software stored in a memory of device 200 and running on a processor circuit of device 200. Ideally, the lighting model 222 is the same model as is used by controller 110. For example, the lighting model could take as input data of the occupancy sensors and the other factors, e.g., of the light sensors, and produces as output a control signal for the luminaires. For the other factors, e.g., of the light sensors fictional data may be used, in particular a constant value. The model may be used to compute an energy consumption estimate, by providing the model with the occupancy information, and with fixed values of the unknown factors, e.g., inputs of the data model corresponding to light sensors may be set to a value corresponding with maximum darkness, e.g., 0. For example, the lighting data may correspond to a dark room without illumination. Such a light sensor response may be measured.

Based on the inputs, the lighting model computes control signals for the luminaires. For example, the control signals may comprise dimming levels for the luminaires. From the dimming levels and the full energy rating, energy ratings for the dimmed luminaires may be computed. The lighting model 110 may take into account various factors which are not taken into account in the simpler estimations. For example, the data model may use different dimming levels at different times of the day. For example, the data model may use different dimming levels for areas with different types of activities; e.g., typing requires different illumination than say assembly. Finally, the energy use of the luminaires may be estimated from the dimming level, and if needed, summed, e.g., for control zones. An advantage of using a data model is that good estimates can be obtained of the energy. Unfortunately, the data model is often proprietary information, and not available to the verification device. Furthermore, installing the data model comes at additional complexity, which may be undesired especially if many lighting systems may need to be analyzed.

Verification device 200 comprises a comparator 230. Comparator 230 may have access to, e.g., comprise, an optional residual unit 232 and/or to an optional correlator unit 234. In an embodiment, comparator 230 is configured to compare the energy consumption estimate to the received energy consumption data and detect if a conformance therebetween is within a threshold. In other words, comparator 230 triggers if the energy estimate is too good. If a good estimate of energy consumption can be made on the basis of partial information, e.g., without taking the other factors, such as light sensors, into account, then apparently those other factors do not play a role after all. If a lighting system with light sensors is installed, yet its energy consumption may be estimated without it, it is a fair assumption that there is a problem with the light sensors, e.g., they are not taken into account or malfunction for some reason.

Device 200 comprises a signal generator 240 which may be trigged by comparator 230 in case a too good estimate is found. For example, signal generator 240 may be configured to transmit a signal indicating a lack of dependency of the lighting system on the other factors. For example, signal generator 240 may send an email, or a report, or an SMS or the like. Signal generator 240 may comprise a display, e.g., a monitor, for displaying the signal. For example, the signal may indicate which luminaire or which control zone seems to be independent of the other factors.

There are number of ways in which the energy estimate may be compared to an actual energy measurement. For example, comparator 230 may use the optional residual unit 232. Residual unit 232 is configured to compute a residual signal as the difference between the received energy consumption and the estimated energy consumption. Detecting a conformance within a threshold may then comprise detecting that the residual signal is below a threshold. For example, the estimate and measurement may be subtracted point wise, e.g., per time moment. For example, the measurement may be subtracted from the estimate, since often the latter is smaller than the former. However, this is not needed. The residual signal may be compared in absolute value, e.g., an absolute value operator may be applied to the difference signal to obtain the residual signal. Determining that the residual signal is below a threshold may comprise computing an integral of the residual signal over a time period, e.g., over a day, and comparing the integral with a threshold value. Determining that the residual signal is below a threshold may be done by determining that the residual signal is always below a threshold value, e.g., in absolute value. A residual signal may also be formed by dividing the estimated energy used by the actual energy use, or vice versa. For small values of the estimated energy used and/or the actual energy use this may set to a fixed, value, e.g., to 0.

The residual signals may be used for further verifications. For example, as part of the verifications, residual signals may be obtained for multiple control zones, or for multiple luminaires. Even if the difference of a residual signal is not below a threshold, further use of them may be made. For example, suppose two residual signals have been computed for two different sets of luminaires. In this case, a set may be, e.g., a single luminaire, or a single control zone, etc. For example, in an embodiment, comparator 230 is configured to use correlator 234. Correlator 234 is configured to compute a correlation between the two residual signals, and transmit the signal if the correlation is below a threshold, e.g., the absolute value of the correlation. The correlation may be computed over a time period, say a day, a week, etc.

For example, suppose that neither of the two signals is a too-good approximation of the actual energy use. As a result, the effect of the other factors, e.g., of the light sensors, has become even more pronounced in the residual signal. Such other factors are likely similar for similar luminaires/control zones, especially if they are near. Accordingly, if the residual signals have a low correlation one of the two may have a problem with the other factors. Correlation may be used with either type of residual signal, in particular with a difference and with a division type.

In an embodiment, the configuration storage 250 stores a distance indication from the one or more luminaires to a window, the two sets having a distance indicating within a threshold. For example, the distance indication may be the row number, e.g., the row number counting from or towards a window, e.g., as in FIG. 2. Having a distance indicating within a threshold may be mean being in the same row. It may also mean that the distance in, say, meters, to the window is close, e.g., within 10%, within 5%, or within 2 meters, etc. In an embodiment, comparator 230 computes correlations between residual signals only for residual signals that have a similar distance indication, e.g., are in the same row. In an embodiment, comparator 230 computes correlations between residual signals only for residual signals that have a similar distance indication, e.g., are in the same row, and which are close to an external light source, e.g., the window, e.g., having a distance indication below a threshold. The threshold may be a difference in energy consumption, hence the threshold of maximum of 10% or 5% difference in energy consumption.

The comparator 230 may use further information, e.g., external lighting data. The external lighting data may be obtained from an optional further sensor 236. The further sensor may be a building light sensor, e.g., arranged outside of the building. The external lighting data may be blinds information, which may be taken from a blinds system. The blind information is correlated to the amount of light that is received at a window. A residual signal, especially corresponding to a luminaire or control zone close to a window is expected to correlate high with the external lighting data. For example, in an embodiment the comparator is configured to select a control zone located close to a window, receive external lighting information, e.g., from a building sensor and compute a correlation. If the correlation is low, there may be a problem.

In the various embodiments of device 200, the communication interface may be selected from various alternatives. For example, the interface may be a network interface to a local or wide area network, e.g., the Internet, a storage interface to an internal or external data storage, an application interface (API), etc.

The verification device may have a user interface, which may include well-known elements such as one or more buttons, a keyboard, display, touch screen, etc. The verification device may also have a user interface. The user interface may be arranged for accommodating user interaction for performing a verification action, e.g., uploading or receiving energy and occupation information and/or receiving information signals indicating possible problems with the lighting system 100.

Verification device 200 may comprise a configuration storage 250 and may also comprise other storage, e.g., for storing the received data, for storing computer software implementing a verification method, and the like. The storage, e.g., storage 250 may be implemented as an electronic memory, say a flash memory, or magnetic memory, say hard disk or the like. The storage may comprise multiple discrete memories together making up the storage. The storage may also be a temporary memory, say a RAM. In the case of a temporary storage, the storage may contain means to obtain data before use, say by obtaining them over an optional network connection.

Typically, the verification device 200 comprises a microprocessor (not separately shown in FIG. 3) which executes appropriate software stored at the device 200; for example, that software may have been downloaded and/or stored in a corresponding memory, e.g., a volatile memory such as RAM or a non-volatile memory such as Flash (not separately shown). The controller device 110, luminaires and sensors may also be equipped with microprocessors and memories (not separately shown in FIGS. 1 and 2). Alternatively, verification device 200 may, in whole or in part, be implemented in programmable logic, e.g., as field-programmable gate array (FPGA). Verification device 200 may be implemented, in whole or in part, as a so-called application-specific integrated circuit (ASIC), i.e. an integrated circuit (IC) customized for their particular use. For example, the circuits may be implemented in CMOS, e.g., using a hardware description language such as Verilog, VHDL etc.

In an embodiment, verification device 200 comprises a communication interface circuit, an energy estimator circuit, a comparator circuit and a signal generator circuit, and optionally a lighting model circuit, a residual unit circuit and/or a correlator unit circuit. The circuits implement the corresponding units described herein. The circuits may be a processor circuit and storage circuit, the processor circuit executing instructions represented electronically in the storage circuits.

A processor circuit may be implemented in a distributed fashion, e.g., as multiple sub-processor circuits. A storage may be distributed over multiple distributed sub-storages. Part or all of the memory may be an electronic memory, magnetic memory, etc. For example, the storage may have volatile and a non-volatile part. Part of the storage may be read-only.

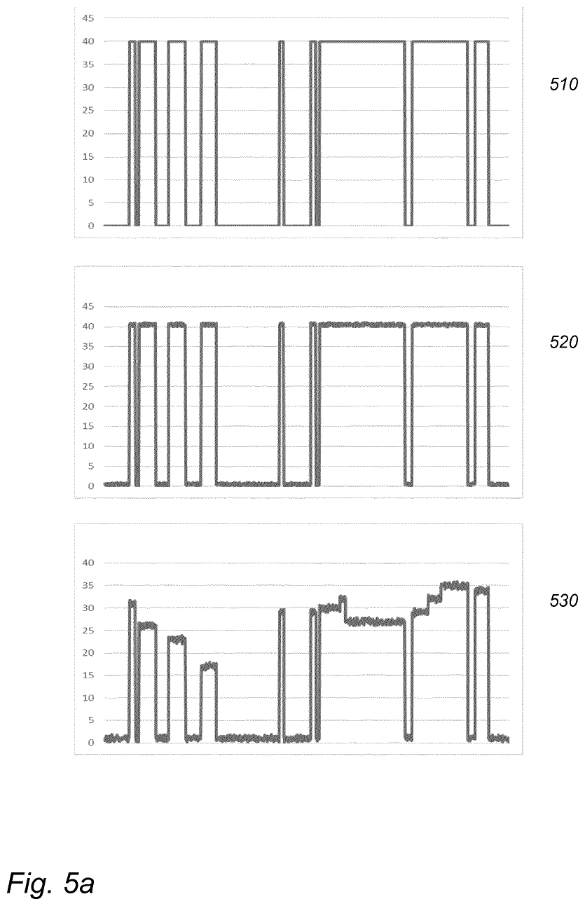

Further embodiments are illustrated with reference to FIG. 4. FIG. 4 schematically shows an example of an embodiment of a building floor 400. Shown in FIG. 4 is a verification device 440. Shown in floor 400 are various rooms and hallways, but most of floor 400 is taken up by a large open office. A window 420 is also shown in floor 400. Verification device 440 receives occupation data 432 and energy consumption data 434 from a lighting system installed in floor 400. The lighting system comprise control zones 401-410. Moreover, the lighting system uses both occupancy sensors and light sensors, e.g., for each control zone. Verification device 440 does not have access to the light sensor data. Verification device 440 is connected to a configuration storage 450. If verification device 440 detects a problem with the lighting system in floor 400, it generates a signal 436. Note that the zones 404, 403, 402, 401 are closer to window 420 than other zones. For example, zones 404, 403, 402, 401 may receive a ‘row 1’ distance indication, zones 407, 406, 405 a ‘row 2’ indication, and zones 410, 409 and 408 a ‘row 3’ distance indication. Configuration storage 450 may for example, store context data. For example, Configuration storage 450 may store, e.g., the mapping of sensors and luminaires to control zones, the coordinates of sensors, luminaires and control zones, the level and/or type of daylight ingress, and the design intent configuration. For example, in an embodiment, configuration store 450 may store the following information:

### Zone 1: {1, 2, 3, 4, 5, 6, 7}

### Zone 1: row 1

Zone 1: daylight controls enabled

### Zone 2: {8, 9, 10, 11, 12, 13, 14, 15}

### Zone 2: row 1

Zone 2: daylight controls enabled
. . .

### Zone 10: {76, 77, 78, 79, 80}

### Zone 10: row 3

Zone 10: daylight controls enabled

The numbers in the curly braces refer to IDs of luminaires and/or sensors. Configuration store 450 also stores that for all these zones daylight controls are enabled. However, this may be faulty, and can be verified by verification device 440.

In an embodiment, verification device 440 may be configured for one or more of the following: obtaining a residual of installed power*occupancy and lighting energy consumed at different time instants at different building hierarchical levels e.g., at luminaire and control area levels; correlating residual signals across different logically neighborhood luminaires and/or control zones; correlating residual signals across different logically neighborhood luminaires and/or control zones with external environmental data like daylight availability for example measured by a building sensor and/or other building system data like blind configurations; using some of these options to diagnose and validate daylight controls, e.g., in relation to the intended design configuration.

The occupancy sensors and light sensors may be used in the lighting systems to adapt to presence and daylight conditions. The output of one or more sensors is used to control a group of luminaires that form a control zone. This is depicted in FIG. 4, where the lighting system is shown over an office space that is divided into 10 control zones. As example, zone 401 consists of 7 luminaires/sensors labelled 1-7. Additional context data says that zones 401-404 are in row 1 with respect to daylight ingress, and that daylight controls has been enabled. In this example, in zone 402 daylight controls might, e.g., be disabled due to a misconfiguration. That is, the design intent as is to have daylight controls enabled, but the data may show that in reality it is not. Data from the lighting system in the form of occupancy and lighting energy consumption is available at sensor/luminaire level. This data is collected and available at verification device. The context data is also available at the verification device.

Denote Ek(ti−tj) to be the lighting energy consumption for the k-th luminaire/control zone over time interval ti−tj. Let Pk be the installed power for the k-th luminaire/control zone, and Ok(ti−tj) be the representative occupancy over the time interval ti−tj. The quantity Pk*Ok(ti−tj) is an example of estimated lighting energy consumption taking in to account the effect of occupancy controls. For example, control zones 401-410 may have index 1-10.

Compute the residual rk(ti−tj)=Pk*Ok(ti−tj)−Ek(ti−tj). A daylight control is expected to be active if the residual exceeds a certain threshold value. If the value is below the threshold, various context data may be checked to further verify if there are problems with the daylight control. For example, level/type of daylight ingress, blind configurations (e.g. are blinds down), external daylight conditions, before establishing that daylight controls are not functioning properly or disabled. If this is not the design intent for daylight controls, then feedback is provided to a lighting configuration system to fix this. The interval ti-tj may have a duration of a few minutes or an hour, etc. These residuals are computed over sufficiently long periods of time, e.g., weeks or months so that the different effects of the environment (like weather, blinds) are taken in to account. A second confirmation may be made by correlating the residual with external data sources that capture variation of daylight representative in the said space.

Now consider two logically adjacent luminaires/zones indexed m and n, or having a similar distance indication, etc. It would be expected that if daylight control is enabled that the residual signals are high and correlated. This corr({rm(ti−tj)}, {m(ti−tj)}) is a feature that may be used for diagnosing whether daylight control is properly functioning. In FIG. 5a, we consider luminaires 1 and 3 that are in control zone 401. Graph 510 shows on the vertical axis Pk*Ok (Wh). Graphs 520 and 530 show on the horizontal axis Ek (Wh). The top subfigure shows the signal Pk*Ok, e.g., an estimate of energy use. The second and third subfigures show the measured lighting energy consumption at luminaires 1 and 3. It can be observed that the residual energy consumption at luminaires 1 and 3 are respectively small and large. Moreover, the residual energy consumption at luminaire 3 can be correlated to external daylight data source and this would confirm that daylight is functional.

In an embodiment, a collection of these features may further be used in a machine learning routine. In a training phase, the feature set may be computed and labelled (e.g. feature set for properly functioning daylight control, feature set for daylight control disabled, feature set for miscellaneous daylight control misconfigurations). In a subsequent online phase, the learnt machine learning classifier is then used for classifying the state of daylight controls. For example, the classifier may receive as input energy consumption over a period, and occupation data over the same period. During training of the classifier, also the input is provided if daylight controls are enabled or not. It is however, noted that good results with detecting configuration problems have been achieved even without machine learning.

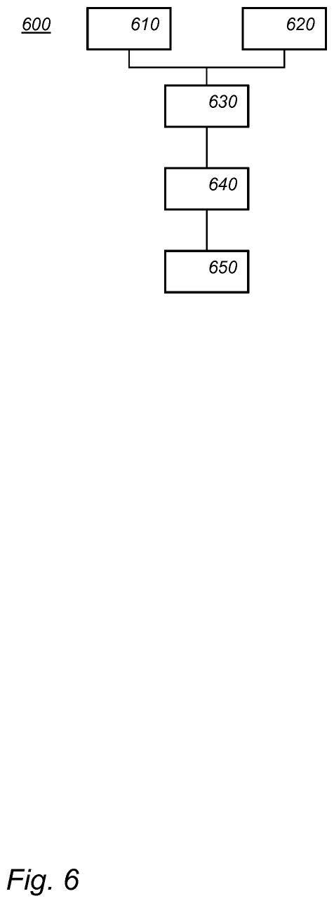

FIG. 6 schematically shows an example of an embodiment of a lighting system verification method 600. The lighting system, may be as lighting system 100, e.g., comprising multiple luminaires 121, 122, 131, 132 and occupancy sensors. The lighting system is configured to control the multiple luminaires at least partly in response to the occupancy sensors and partly in response to other factors. The other factors may be light sensors. The method comprises acts of:
receiving 610 energy consumption data indicating energy consumption of one or more of the luminaires, and receiving 620 occupancy data indicating detected occupancy of one or more occupancy sensors, at least one of the luminaires being controlled dependent upon the one or more occupancy sensors,
computing 630 an energy consumption estimation for the one or more luminaires from the occupancy data,
comparing 640 the energy consumption estimation to the received energy consumption data and detect if a conformance therebetween is within a threshold, and if so
transmitting 650 a signal indicating a lack of dependency of the lighting system on the other factors.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. For example, steps 610, 620 and 630 may be executed, at least partially, in parallel. Moreover, a given step may not have finished completely before a next step is started.

A method according to the invention may be executed using software, which comprises instructions for causing a processor system to perform method 600. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. A method according to the invention may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source, and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

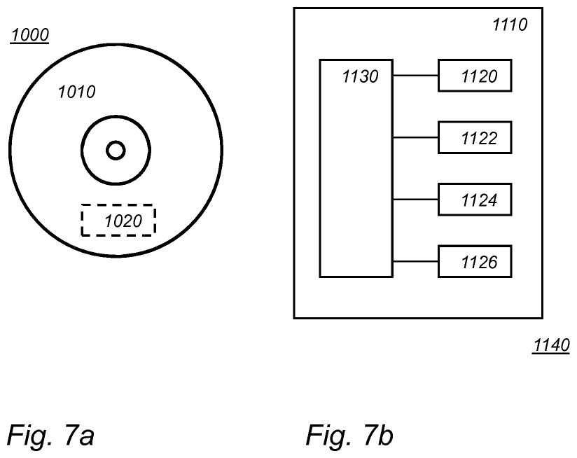

FIG. 7a shows a computer readable medium 1000 having a writable part 1010 comprising a computer program 1020, the computer program 1020 comprising instructions for causing a processor system to perform a light system verification method, according to an embodiment. The computer program 1020 may be embodied on the computer readable medium 1000 as physical marks or by means of magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said light system verification method.

FIG. 7b shows in a schematic representation of a processor system 1140 according to an embodiment of a light system verification device. The processor system comprises one or more integrated circuits 1110. The architecture of the one or more integrated circuits 1110 is schematically shown in FIG. 7b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, the light system verification device may comprise a processor circuit and a memory circuit, the processor being arranged to execute software stored in the memory circuit. For example, the processor circuit may be an Intel Core i7 processor, ARM Cortex-R8, etc. In an embodiment, the processor circuit may be ARM Cortex M0. The memory circuit may be an ROM circuit, or a non-volatile memory, e.g., a flash memory. The memory circuit may be a volatile memory, e.g., an SRAM memory. In the latter case, the device may comprise a non-volatile software interface, e.g., a hard drive, a network interface, etc., arranged for providing the software.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb ‘comprise’ and its conjugations does not exclude the presence of elements or steps other than those stated in a claim. The article ‘a’ or ‘an’ preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

In the claims references in parentheses refer to reference signs in drawings of exemplifying embodiments or to formulas of embodiments, thus increasing the intelligibility of the claim. These references shall not be construed as limiting the claim.

1. A verification device for verifying a lighting system comprising multiple luminaires, light sensors and occupancy sensors, the lighting system being configured to control said multiple luminaires at least partly in response to said occupancy sensors and partly in response to said light sensors, the verification device comprising:
a communication interface arranged to receive:
energy consumption data indicating energy consumption of one or more of the luminaires,
occupancy data indicating detected occupancy of one or more occupancy sensors, at least one of the luminaires being controlled dependent upon the one or more occupancy sensors,
wherein the occupancy data and the energy consumption data correspond to a same time period, said time period being during daytime;
a processor circuit configured to:
compute an energy consumption estimate for the one or more luminaires from the occupancy data,
compare the energy consumption estimate to the received energy consumption data and detect if a conformance therebetween is within a threshold, and if so
transmit a signal indicating a lack of dependency of the lighting system on light sensor measurements of the light sensors.

2. A verification device as in claim 1 configured to verify configuration of the lighting system without access to the light sensor measurements.

3. A verification device as in claim 1, wherein the processor circuit is configured to compute a residual signal as the difference between the received energy consumption and the estimated energy consumption, wherein detecting a conformance within a threshold comprises detecting that the residual signal is below a threshold.

4. A verification device as in claim 1, wherein computing the energy consumption estimate comprises:
estimating which of the one or more luminaires are turned on from the occupancy data,
estimating the energy consumption of the luminaires which are estimated to be turned on.

5. A verification device as in claim 1, wherein computing the energy consumption estimate comprises:
estimating a dimming level of the one or more luminaires from the occupancy data,
estimating the energy consumption of the luminaires from the estimated dimming level.

6. A verification device as in claim 1, wherein the lighting system is configured to control the multiple luminaires according to a lighting model, said lighting model taking as input data of the occupancy sensors and the light sensors, and configured to produce as output a control signal for the luminaires, wherein computing the energy consumption estimate comprises:
determining the response of the lighting model on the basis of the received occupancy data and constant lighting data,
summing the estimated energy consumption.

7. A verification device as in claim 6, wherein the constant lighting data is lighting data which corresponds to a dark room without illumination.

8. A verification device as in claim 1, comprising a configuration storage, the configuration storage storing one or more of:
an assignment of luminaires to occupancy sensors,
rated power consumption of the luminaires,
a location of the luminaires, and,
a dimming relation between occupancy sensors and luminaires.

9. A verification device as in claim 1, wherein the processor circuit is configured to
compute two residual signals for two different sets of luminaires,
compute a correlation between the two residual signals,
transmit the signal if the correlation is below a threshold.

10. A verification device as in claim 9, comprising a configuration storage storing a distance indication from the one or more luminaires to a window, the two sets having a distance indication within a threshold.

11. A verification device as in claim 2 in combination with any one of the preceding claims, wherein
the communication interface is arranged to receive external lighting data, e.g., from a building light sensor arranged outside of the building, or blind configurations, the processor circuit being arranged to compute a correlation between the residual signal and the external lighting data and to transmit the signal if the correlation is below a threshold.

12. A lighting system comprising multiple luminaires, light sensors occupancy sensors, and a lighting controller, the lighting controller being configured to control said multiple luminaires at least partly in response to said occupancy sensors and partly in response to said light sensors, the lighting system further comprising a verification device as in claim 1.

13. A verification method for a lighting system, said lighting system comprising multiple luminaires, light sensors and occupancy sensors, the lighting system being configured to control said multiple luminaires at least partly in response to said occupancy sensors and partly in response to said light sensors, the method comprising:
receiving energy consumption data indicating energy consumption of one or more of the luminaires, and receiving occupancy data indicating detected occupancy of one or more occupancy sensors, at least one of the luminaires being controlled dependent upon the one or more occupancy sensors, wherein the occupancy data and the energy consumption data correspond to a same time period, said time period being during daytime;
computing an energy consumption estimate for the one or more luminaires from the occupancy data,
comparing the energy consumption estimate to the received energy consumption data and detect if a conformance therebetween is within a threshold, and if so
transmitting a signal indicating a lack of dependency of the lighting system on light sensor measurements of the light sensors.

14. A computer readable medium comprising non-transitory data representing instructions to cause a processor system to perform the method according to claim 13.
